(19) United States
(12) Patent Application Publication
(10) Pub. No.: US 2026/0284558 A1
(43) Pub. Date: Sep. 24, 2026

(54) ADJUSTABLE WEIR FOR A COLLECTION TROUGH, A COLLECTION TROUGH AND A COLLECTION TROUGH ASSEMBLY

(71) Applicant: Roberts Water Technologies, Inc., Coatesville, PA (US)

(72) Inventor: R. Lee Roberts, Rose Valley, PA (US)

(21) Appl. No.: 19/087,882

(22) Filed: Mar. 24, 2025

(51) Int. Cl. B01D 24/46; B01D 24/14; C02F 1/00

(52) U.S. Cl. CPC B01D 24/4631; B01D 24/14; C02F 1/004; B01D 2101/04; C02F 2303/16

(57) ABSTRACT

A weir for a collection trough, a collection trough and a collection trough assembly. A plurality of screening sections are formed in the weir. The weir may be adjustable. The plurality of screening sections each having a plurality of slots sized to perform a screening function in which liquid and solid particles having a size less than a predetermined size can pass through anyone of the plurality of slots while solid particles having a size equal to or greater than the predetermined size cannot pass through any of the plurality of slots of the screening sections. Alternatively, or in addition to the screening sections of the weir, screening sections can be formed in one or both sidewalls of a collection trough. A tapered collection trough with or without screening sections is provided to significantly reduce material costs and/or create an observation area between two closely positioned tapered troughs.

### FIELD OF THE INVENTION

Preferred forms of the present invention are directed to controlling, in a particular manner, entry of liquids and solid particles into a collection trough (e.g., wash trough) and/or sizing the employed collections troughs to significantly reduce material costs and/or create an observation area between two closely positioned collection troughs.

Preferred forms of the present invention are directed to a weir for a collection trough, a collection trough and a collection trough assembly.

On preferred form of the present invention is directed to a weir in the form of a plate-like structure having one or more screening sections. Each screening section of the weir preferably includes a plurality of slots (e.g., micro-slots) sized to perform a screening function in which liquid and solid particles having a size less than a predetermined size can pass through anyone of the plurality of slots of a corresponding screening section and enter a corresponding collection trough, device or structure while solid particles having a size equal to or greater than the predetermined size cannot pass through any of the plurality of slots of the corresponding screening section.

A weir having one or more the screening sections is particularly useful in water or wastewater treatment units employing a granular media bed to remove impurities from liquids passing through (e.g. upwardly or downwardly) the granular media bed. Granular media beds typically have one or more layers of filter media having a predetermined effective size.

Overtime, some of the granular media making up a clarifier or filter layer will become fragmented or worn down causing deleterious effects on filtration, e.g., reducing the efficiency of the clarifier or filter bed during a filtration or clarification cycle.

The one or more screening sections of the preferred weir are configured to block larger media particles from entering a corresponding collection trough while allowing fragmented or deteriorated portions of media particles (i.e., “media fines”) created overtime to pass therethrough and enter the collection trough through which the “media fines” are removed from the compartment housing the filter/clarifier bed of the water or wastewater treatment unit.

Each of the slots of the one or more screening sections are preferably sized primarily based upon the effective size of the one or more layers of filter or clarifier media of the filter bed housed in a compartment of a water or wastewater treatment unit. For example, each of the slots can be sized to have a width that is only a percentage of the effective size of a layer of filter/clarifier media where the percentage is less than 100% of the effective size of the layer of filter/clarifier media of the filter/clarifier bed.

One percentage believed to be optimal is approximately 75%. Accordingly, where the effective size of the filter layer is 1 mm the slot width would be approximately 0.75 mm. Where the slots have a width of approximately 0.75 mm, “media fines” (i.e., granular particles that have deteriorated overtime or become fragmented of less than approximately 0.75mm) will pass through a corresponding slot with the liquid to be treated and enter a corresponding collection trough and subsequently be removed from the compartment of the water or wastewater treatment unit housing the filter or clarifier bed while media having a size equal to or greater than approximately 0.75 mm will be blocked from passing through any of the slots of a screening section and thereby be prevented from entering the collection trough.

In this manner, the desired size of media in a filter layer for optimal filtration or clarification will remain in the filter/clarifier bed while the undesirable “media fines” will be readily removed from the compartment housing the filter/clarifier bed by way of the collection trough.

While liquid will enter the collection trough through the slots, it is to be noted that the uppermost portion or top surface of the weir will still perform the function of a weir as liquids will pass over the uppermost portion or top surface of the weir and enter the corresponding collection trough.

It is to be noted that the particular percentage of the effective size of the filter/clarifier media that the width of each of the slots of the one or more screening sections is based on can be readily varied from that of approximately 0.75%. Further, it will be appreciated that what size constitutes “media fines” will vary depending upon the effective size of the filter or clarifier bed.

The preferred form of weir can be oriented parallel to the direction of gravity or can be oriented at an angle to the direction of gravity wherein at least a portion of the weir is not parallel to the direction of gravity. One non-parallel orientation is one in which at least a major portion of the weir plate is angled inwardly so that the weir extends toward a vertical plane passing through a center of a corresponding collection trough, i.e., a lowermost portion of the weir is at a distance from the vertical plane passing through a center of a corresponding collection trough greater than the distance an uppermost portion of the weir is spaced from the same vertical plane. A bottom portion of the weir can have a complimentary shape to that of a corresponding portion of a collection channel to facilitate the connection of the weir to the collection trough.

Another non-parallel orientation is one in which the weir plate is angled outwardly so that at least a major portion of the weir extends away from a vertical plane passing through a center of a corresponding collection trough i.e., a lowermost portion of the weir is at a distance from the vertical plane passing through a center of a corresponding collection trough less than the distance an uppermost portion of the weir is spaced from the same vertical plane. Again, a bottom portion of the weir can have a complimentary shape to that of a corresponding portion of a collection channel to facilitate the connection of the weir to the collection trough.

By orienting the weir in either of the non-parallel positions discussed above, the size of the body of the weir having the one or more screening sections can be increased while still maintaining the uppermost surface of the weir at the same or similar height from the top of the filter/clarifier bed as in the parallel position of the weir. Accordingly, a greater total screening area is created by the larger area of the one or more screening sections oriented in the non-parallel positions.

The non-parallel positioning could be at a 45 degree angle bending or extending either inwardly or outwardly from a vertical plane passing through the junction point of the weir and a corresponding portion of the collection trough.

The weir may be adjustable by providing a plurality of openings (e.g., vertically extending elongated openings or slots) sized to allow a position the adjustable weir is connected to the side wall of the collection trough to be varied to, for example, compensate for collection troughs that are tilted upwardly or downwardly so that uppermost surface of the weir extends in a horizontal plane perpendicular to a direction of gravity despite the fact that the uppermost surface of a corresponding collection trough extends in a plane that is not perpendicular to the direction of gravity. In this manner, errors in installation of a corresponding collection trough can be readily overcome by the adjustable weir.

Another preferred form the present invention is directed to a collection trough having one or more screening sections in one or both side walls of the collection trough. Each screening section in this preferred embodiment are formed in a manner that is the same or similar to the one or more screening sections of the weir discussed above. It should be noted that a weir could be used with the collection trough of this embodiment wherein the weir plate has one or more screening sections or lacks any screening section.

A further preferred embodiment is directed to a collection trough where the opposing side walls of the collection trough each have a uniform height across a length of at least a major portion of the collection trough and the bottom of collection trough has a varying width over at least a major portion of the collection trough so that the width of a collection channel formed by the bottom and the opposing side walls varies over at least a major portion of the collection trough. The tapered collection trough of this preferred embodiment significantly reduces material costs. This tapered collection trough optionally includes one or more screening sections of the type described above. A weir having one or more screening sections can also be used with this tapered collection trough.

Yet a further preferred embodiment is directed to a collection trough assembly that employs one or more sets of tapered collection troughs with each set of the tapered collection troughs including at least two closely spaced tapered collection troughs. Preferably, a first end of each of the at least two closely spaced tapered collection troughs is connected to a single wash trough opening formed in a wall of a compartment of a water or wastewater treatment unit so that liquid collected by the tapered collection troughs of one set of tapered collection troughs exits the compartment of the treatment unit through the single wash trough opening. An adapter of the type disclosed in U.S. Pat. No. 12,053,722 can be used to connect each of the tapered collection troughs of a given set of tapered collection troughs to only one wash trough opening. The entire contents of U.S. Pat. No. 12,053,722 are incorporated herein by reference.

Preferably, each tapered collection trough is tapered inwardly in a direction extending away from the corresponding wash trough opening so that the end of each tapered collection trough adjacent the wash trough opening has a width significantly greater than the opposing end of the corresponding tapered collection trough. In this manner, an enlarged observation area is formed between two adjacent and closely spaced collection troughs at or adjacent the ends having a smaller width. The taper can be achieved by way of slanting inwardly only one of the two opposing side walls of a corresponding collection trough so that the inwardly slanted side wall does not extend parallel to a vertical plane passing through and bisecting a corresponding wash trough opening while the non-slanted side wall of the corresponding collection trough extends parallel to the same vertical plane. Each of the tapered collection troughs of this embodiment may optionally include one or more screening sections of the type described above. Similarly, each of the tapered collection troughs of this embodiment may optionally include a weir having one or more screening sections.

The collection troughs of the various preferred embodiments of the present invention may be shallow wash troughs to allow the total volume of filter or clarifier media to be significantly increased as discussed in detail in U.S. Pat. No. 12,053,722. However, any of the collection troughs of the preferred forms of the present invention can be sized to having any desired collection volume.

### BACKGROUND OF THE INVENTION

Various devices have been developed to pretreat or treat water or wastewater including but not limited to sedimentation basins, clarifiers and polishing filters. Sedimentation basins can be used to pretreat liquids prior to entering a corresponding polishing filter or other treatment device or apparatus. Clarifiers can also be used to pretreat liquids prior to entering a corresponding polishing filter or other treatment device or apparatus.

Collection troughs can be used in a wide variety of water and/or wastewater treatment units including but not limited to sedimentation basins, clarifiers and polishing filters to perform well-known collection functions. Conventional weirs used in connection with existing collection troughs are often impeded by floating debris which hampers the collection trough from performing optimally.

Also, known collection troughs lack any means, including but not limited to a weir associated therewith or the collection trough itself, that can perform a screening function in which “media fines” are allowed to enter the collection trough with a carrying liquid and removed from the treatment unit while larger media particles are blocked or prevented from entering the collection trough and thus retained in the treatment unit. Rather, known devices using a filter bed to remove impurities from a liquid to be treated are not capable of removing only “media fines” during a cycle, stage or phase of operation of the treatment unit (e.g., a washing cycle, stage or phase in which the filter bed is washed or cleaned to remove impurities trapped during a filtering or clarifying cycle, stage or phase) while retaining larger media particles in the treatment unit. The presence of “media fines” in a treatment unit can significantly decrease the efficiency of the treatment unit.

The above discussion describes just a few of the shortcomings of the prior art that various preferred embodiments of the present invention overcome.

### OBJECTS AND SUMMARY OF THE INVENTION

An object of a preferred form of the present invention is to provide a novel and unobvious device and/or process for increasing the efficiency of treatment units for treating water or wastewater.

Another object of a preferred form of the present invention is directed to one or more devices for controlling, in a particular manner, entry of liquids and solid particles into a collection trough (e.g., wash trough) and/or sizing the employed collections troughs to significantly reduce material costs and/or create an observation area between two closely positioned collection troughs.

A further object of a preferred form of the present invention is directed to a weir in the form of a plate-like structure having one or more screening sections wherein each screening section includes a plurality of slots (e.g., micro-slots) sized to perform a screening function in which liquid and solid particles having a size less than a predetermined size can pass through anyone of the plurality of slots of a corresponding screening section and enter a corresponding collection trough, device or structure while solid particles having a size equal to or greater than the predetermined size cannot pass through any of the plurality of slots of the corresponding screening section.

Still another object of a preferred form of the present invention is directed to an adjustable weir plate having one or more screening sections wherein each screening section includes a plurality of slots sized based at least in part on the effective size of a filter or clarifier layer to perform a screening function in which liquid and solid particles having a size less than a predetermined percentage (e.g., approximately 75%) of the effective size of the filter or clarifier media can pass through anyone of the plurality of slots of a corresponding screening section and enter a corresponding collection trough, device or structure while solid particles having a size equal to or greater than the same percentage of the effective size cannot pass through any of the plurality of slots of the corresponding screening section.

Still a further object of a preferred form of the present invention is directed to a collection trough in which one or both of the side walls of the collection trough have one or more screening sections formed therein wherein each screening section includes a plurality of slots (e.g., micro-slots) sized to perform a screening function in which liquid and solid particles having a size less than a predetermined size can pass through anyone of the plurality of slots of a corresponding screening section and enter a corresponding collection trough, device or structure while solid particles having a size equal to or greater than the predetermined size cannot pass through any of the plurality of slots of the corresponding screening section.

Still a further object of a preferred form of the present invention is directed to a collection trough in which one or both of the side walls of the collection trough have one or more screening sections formed therein wherein each screening section includes a plurality of slots sized based at least in part on the effective size of a filter or clarifier layer to perform a screening function in which liquid and solid particles having a size less than a predetermined percentage (e.g., approximately 75%) of the effective size the can pass through anyone of the plurality of slots of a corresponding screening section and enter a corresponding collection trough, device or structure while solid particles having a size equal to or greater than the same percentage of the effective size cannot pass through any of the plurality of slots of the corresponding screening section.

Yet another object of a preferred form on the present invention is directed to a collection trough where the opposing side walls of the collection trough each have a uniform height across a length of at least a major portion of the collection trough and the bottom of collection trough has a varying width over at least a major portion of the collection trough so that the width of a collection channel formed by the bottom and the opposing side walls varies over at least a major portion of the collection trough.

Yet a further object of a preferred form on the present invention is directed to a wash trough assembly including one or more sets of tapered wash troughs with each set including at least two tapered wash troughs that are each connected to a single wash trough opening at a first end and an observation area is created between each of the other ends of the tapered wash troughs to significantly reduce material most while simultaneously creating an observation area for an individual to observe liquid flow during any cycle, phase or stage of operation of a treatment unit despite very close positioning of the two tapered wash troughs of a single set of tapered wash troughs at the ends adjacent the single wash trough opening.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention. Further, the above is not an exhaustive list of the advantages and objects of the preferred forms of the present invention. Other advantages and objects of preferred forms of the present invention will be readily appreciated from the description of the preferred forms of the present invention.

In summary, one preferred embodiment of the present invention is directed to a wash trough assembly for a compartment of a treatment unit housing at least one layer of granular media for removing impurities from water or wastewater passing through the at least one layer of granular media. The wash trough assembly includes at least one wash trough having opposing side walls, a bottom connected to and extending between a lower portion of each of the opposing side walls, a first end and a second end. The first end is configured to be operably associated with a wash trough opening formed in a wall of the compartment of the treatment unit so that a liquid collected by the at least one wash trough exits the compartment of the treatment unit through the wash trough opening. The wash trough assembly further including at least one of the following: (i) an adjustable weir connected to one of the opposing side walls of the at least one wash trough, the adjustable weir having at least one screening section including a plurality of slots sized to perform a screening function in which liquid and solid particles having a size less than a predetermined size can pass through anyone of the plurality of slots of the at least one screening section and enter the at least one wash trough through a corresponding slot while solid particles having a size equal to or greater than the predetermined size cannot pass through any of the plurality of slots of the at least one screening section; (ii) at least one of the opposing side walls of the at least one wash trough having at least one screening section including a plurality of slots sized to perform a screening function in which liquid and solid particles less than a predetermined size can pass through any one of the plurality of slots of the at least one screening section and enter the at least one wash trough through a corresponding slot while solid particles equal to or greater than the predetermined size cannot pass through any of the plurality of slots of the at least one screening section; and, (iii) the at least one wash trough includes a first wash trough, the opposing side walls of the first wash trough each having a uniform height across a length of at least a major portion of the first wash trough, the bottom of the first wash trough having a varying width over at least a major portion of the first wash so that the width of a collection channel formed by the bottom and the opposing side walls varies over at least a major portion of the first wash trough.

Another preferred embodiment of the present invention is directed to an adjustable weir for a collection trough of a treatment unit for treating water or wastewater having a body section extending between a left end, a right end, an upper surface and a lower surface of the adjustable weir. The body section includes a plurality of openings configured to receive a fastener to connect the adjustable weir to a side wall of a collection trough. The plurality of openings are sized to allow a position the adjustable weir is connected to the side wall of the collection trough to be varied. The body section further includes at least one screening section including a plurality of slots sized to perform a screening function in which liquids and solid particles having a size less than a predetermined size can pass through any of the plurality of slots of the at least one screening section and enter the collection trough through a corresponding slot while solid particles having a size equal to or greater than the predetermined size cannot enter the collection trough through any of the plurality of slots of the at least one screening section.

A further embodiment of the present invention is directed to a wash trough assembly for a compartment of a treatment unit housing at least one layer of granular media for removing impurities from water or wastewater passing through the at least one layer of granular media.

The wash trough assembly includes a first wash trough and a second wash trough. The first wash trough and the seconding wash trough each having an inner wall, an outer wall and a bottom connected to and extending between a lower portion of the inner wall and the outer wall, a first end and a second end. The first end of each of the first wash trough and the second wash trough are configured to be operably associated with a single wash trough opening formed in a wall of the compartment of the treatment unit so that a liquid collected by each of the first wash trough and the second wash trough exits the compartment of the treatment unit through the single wash trough opening. A width of a collection channel formed by the inner wall, outer wall and bottom of each of the first wash trough and the second wash trough is tapered so that a width of the collection channel at the second end of a corresponding wash trough is less than a width of the collection channel at the first end of the corresponding wash trough creating an enlarged observation area between the first wash trough and the second wash trough adjacent the second end of the first wash trough and the second end of the second wash trough.

The above summary describes preferred forms of the present invention and is not in any way to be construed as limiting the claimed invention to the preferred forms.

### BRIEF DESCRIPTION OF THE DRAWINGS

FIG. 1 is a perspective view of one preferred form of a weir plate that can be attached to one or both sides of a collection trough (e.g., wash trough) wherein the weir plate includes a plurality of screening sections uniformly spaced along the length of the weir plate and a plurality of elongated slots which are optional and when used are disposed below the plurality of screening sections to permit adjustment of the manner in which the weir plate is attached to a corresponding side of a collection trough to, for example, compensate for a collection trough that is tilted upwardly or downwardly relative to a horizontal axis perpendicular to a direction of gravity.

FIG. 2 is a front elevational view of the weir plate of FIG. 1 as seen from the rear, i.e., the backside of the weir plate as oriented in FIG. 1.

FIG. 3 is an enlarged view of circle A section of FIG. 2 depicting the closed perimeter micro-slots forming a portion of a single screening section and which perform the screening function of a preferred form of the present invention.

FIG. 4 is a perspective view of an example of one of a number of many possible configurations for a collection trough having the weir plate of FIG. 1 connected to each of the opposing sidewalls of the collection trough.

FIG. 5 is a front elevational view of FIG. 4.

FIG. 6 is an end view of FIG. 4.

FIG. 7 is a perspective view of one preferred form of collection trough in which the height of the collection trough is constant along the length of the collection trough and the width of the collection trough varies from the first end to the second end of the collection trough so that the width of the collection trough at one end is considerably less than the width of the collection trough at the opposing end.

FIG. 8 is a plan or top view of the collection trough of FIG. 7.

FIG. 9 is a left end view of the collection trough of FIG. 7.

FIG. 10 is a right end view of the collection trough of FIG. 7.

FIG. 11 is a plan view of the operational position of two closely spaced collection troughs (each of which can be shallow collection troughs or deep collection troughs) each being of the type depicted in FIG. 7 creating an observation area extending between the narrowed or tapered end of each of the two collection troughs.

FIG. 12 is a perspective view of the operational position of the two closely spaced collection troughs depicted in FIG. 11.

FIG. 13 is a perspective view of a preferred water or wastewater treatment compartment (the configuration of the compartment can be readily varied) in which three sets of the two closely spaced collection troughs depicted in FIG. 11 are employed.

FIG. 14 is a perspective view of a modification of FIG. 7 in which each of the opposing sidewalls of the collection trough include a plurality of screening sections uniformly spaced across the length of the collection trough.

FIG. 15 is a front elevational view of FIG. 14.

FIG. 16 is an enlarged detail of circle A section of FIG. 15.

FIG. 17 is a perspective view of a modification of the collection trough of FIG. 7 in which a plurality of four point star shaped screening sections are uniformly spaced along the length of the collection trough.

FIG. 18 is a front elevational view of FIG. 17.

FIG. 19 is an enlarged detail of circle A section of FIG. 18.

### DETAILED DESCRIPTION OF THE PREFERRED

### Embodiments of the Invention

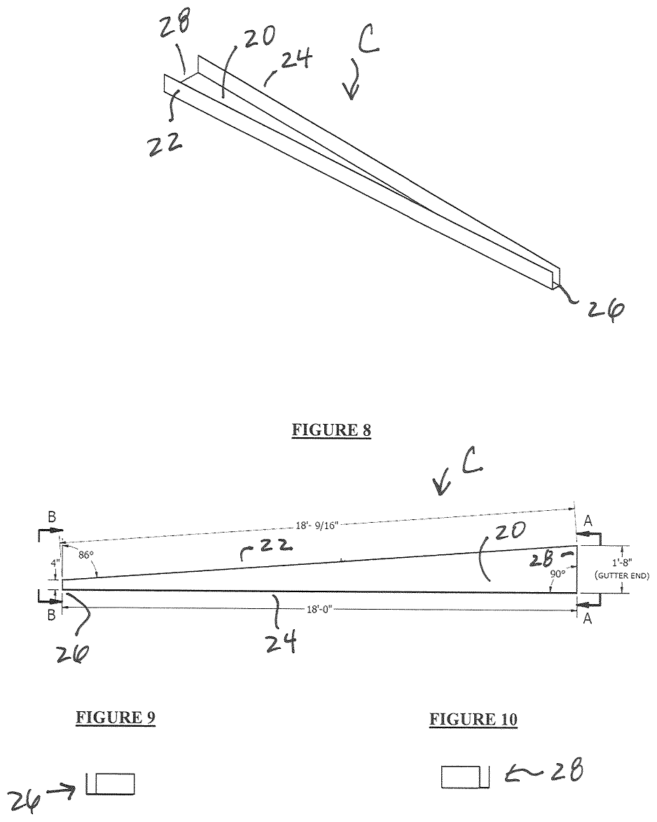

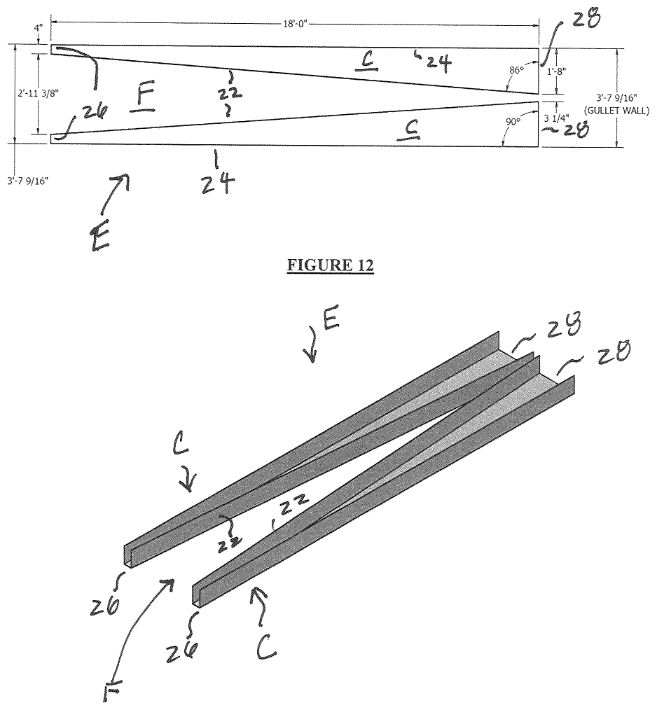

The preferred forms of the invention are described below with reference to FIGS. 1 to 19. The appended claims are not limited to the preferred forms and no term and/or phrase used herein is to be given a meaning other than its ordinary meaning unless it is expressly stated otherwise.

The preferred forms of the present invention may be used in any suitable environment including but not limited to sedimentation basins, clarifiers and polishing filters. The weirs of the preferred forms of the present invention can be used in connection with any collection device including but not limited to collection troughs and wash troughs wherein wash troughs are troughs that function to collect a washing liquid used during a washing cycle, phrase or stage to remove impurities trapped in a filter or clarifier media bed during a filtration or clarification cycle, phrase or stage.

The collection volume of any of the collection and wash troughs of the preferred forms of the present invention can be readily varied. For example, any of the collection and wash troughs of the preferred forms of the present invention can be deep or shallow wash troughs of the type disclosed in U.S. Pat. No. 12,053,722.

The treatment unit, as used herein, can take many forms including a treatment unit in which liquid to be processed (e.g., impurities removed from) travels in the same direction or the opposite direction as the washing fluid be it a gas, liquid or a combination of a gas or liquid as the washing fluids. The treatment unit can be a pretreatment unit proceeding one or more subsequent processing stages. For example, the pretreatment unit can be an upflow clarifier, a downflow clarifier or a sedimentation basin preceding one or more subsequent treatment units. In an upflow clarifier, liquid to be processed (i.e., to have impurities removed therefrom) flows upwardly through the granular media. Conversely, in a downflow clarifier, the liquid to be processed is directed downwardly through the granular media.

The treatment unit can be a final stage of a liquid treatment system including but not limited to an upflow polishing filter and a downflow polishing filter. In addition, the treatment unit can be an intermediary component between a clarifier or other initial treatment component and a final polishing filter or final treatment unit. The treatment unit can take the form of a water treatment unit, a wastewater treatment unit or any device that employs granular media to remove impurities from a fluid or liquid to be processed.

Filter bed and clarifier bed, as used herein, includes a single layer of media that is designed to remove impurities from a liquid to be processed. The single layer of media can be supported directly on an underdrain or on a media retaining plate or structure connected to the underdrain. The filter bed or clarifier bed can include two or more layers of media designed to remove impurities from a liquid to be processed supported directly on the underdrain or on a media retaining plate or structure connected to the underdrain. The one or more layers of media designed to remove impurities from a liquid to be processed may be disposed on one or more layers of support gravel.

### FIGS. 1 to 6

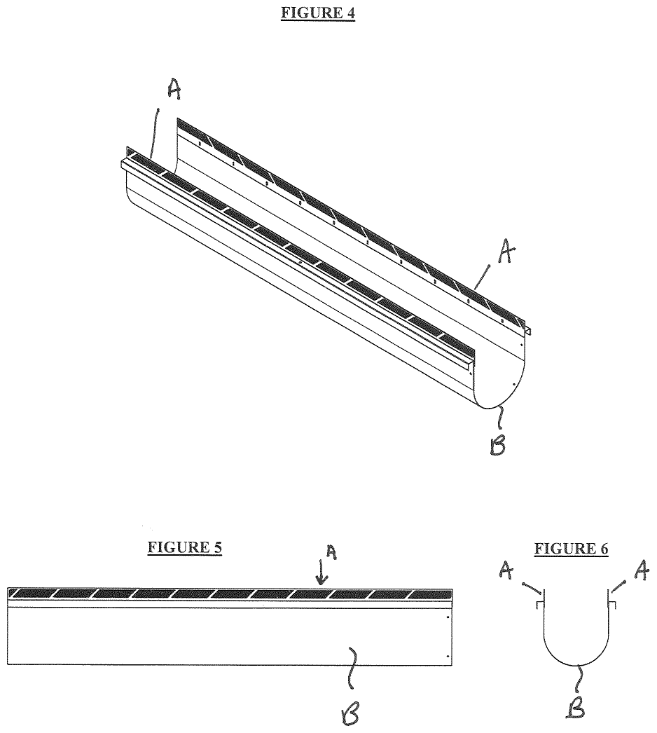

A preferred form of weir will now be described in connection with FIGS. 1 to 6. FIGS. 4 to 6 merely show how the preferred weir can be used in connection with one of many different collection troughs while FIGS. 1 to 3 illustrate a weir formed in accordance with a preferred embodiment of the invention. The weir of FIGS. 1 to 3 can also be used in connection with the troughs of FIGS. 7 to 12 and 14 to 19.

Referring to FIGS. 1 to 3, the preferred form of weir A is a planar plate that can be formed of any suitable material including but not limited to a metal (e.g., stainless steel) or a non-metal (e.g., plastic). Weir A includes a planar body 2 extending between a planar uppermost surface 4, a planar lowermost surface 6, a planar left end 8 and a planar right end 10. The uppermost surface 4 extends parallel to lowermost surface 6 and perpendicular to left end 8 and right end 10.

Body 2 preferably includes a plurality of uniformly spaced openings or slots 12 with each of the slots 12 having an elongated dimension in the direction of gravity to be able to adjust the position of the weir A relative to a trough (collection trough or wash trough) that weir A is connected to when installed in an operating position. The elongated slots 12 are configured to receive a bolt or similar fastener and have a dimension in the direction of gravity significantly greater than a shaft or shank portion of a corresponding fastener (e.g., two to ten times greater than a shaft or shank portion of a corresponding fastener) to permit weir A to be moved up or down relative to the shaft or shank portion prior to fixing weir A to a trough to facilitate an adjustable connection of weir A to a corresponding trough.

For example, if a trough is installed in a position in which the trough is tilted upwardly or downwardly from an optimal operating position, vertically elongated openings 12 allow one or more portions of weir A to be raised or lowered to compensate for the incorrectly installed trough so that the uppermost surface 4 of weir A extends perpendicular to a direction of gravity even though the uppermost surface of the trough does not extend perpendicular to a direction of gravity. While ten (10) elongated openings 12 are shown uniformly spaced along the length of weir A, the number of elongated openings and the spacing between elongated openings 12 can be varied as desired. Further, the dimension of the slots 12 in the direction of gravity can be readily varied as desired. While elongated openings 12 are optional, when used openings 12 are preferably positioned below the screening sections of body 2 discussed below.

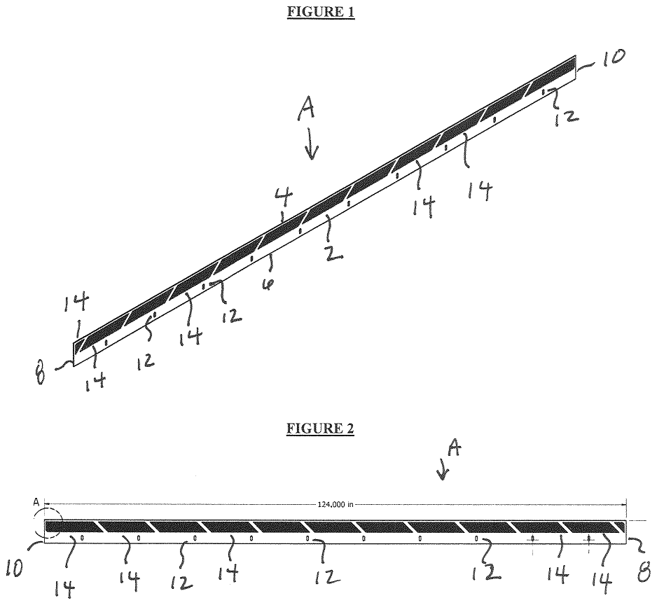

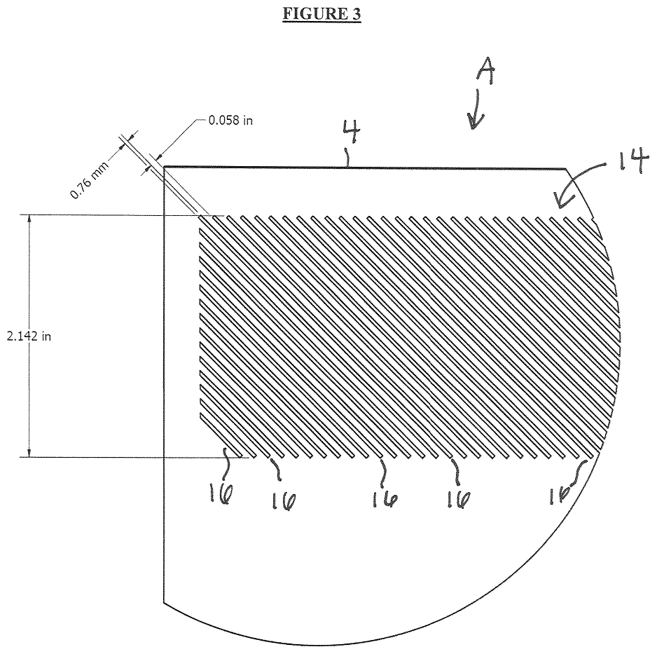

Body 2 includes one or more screening sections 14 shown schematically in FIGS. 1 and 2 as the black sections with a space between adjacent screening sections. Referring to FIG. 3, the configuration of each of the one or more screening sections 14 will be described in detail.

FIG. 3 is an enlargement of the circle “A” section of FIG. 2 taken through a portion of screening section 14 adjacent end 10. Preferably, each screening section 14 includes a plurality of slots 16 that extend completely through the corresponding portion of body 2. As clearly seen in FIG. 3, slots 16 are slanted relative to a direction of gravity, i.e., the slots 16 are neither parallel nor perpendicular to the direction of gravity. However, slots 16 can be oriented parallel or perpendicular to the direction of gravity. Further, some slots could be oriented in a first position relative to a direction of gravity and other slots of the same or a different screening section can be oriented in a second position different from the first position.

In a most preferred form, slots 16 are micro-slots formed by laser cutting. Micro-slot, as used herein, is a slot that has a width less than 2 mm and most preferably less than 1 mm.

In FIG. 3, the width of each of slots 16 is 0.76 mm. Approximately 0.75 mm, as used herein, includes 0.70 mm to and including 0.80 mm. Each slot 16 is spaced from and extends parallel to an adjacent slot 16. One preferred spacing is 0.058 inches. However, the spacing can be readily varied as desired. Each screening section 14 preferably has a height of 2.142 inches. However, the height of any screening section 14 can be readily varied as desired.

An uppermost portion of each screening section 14 is preferably disposed below uppermost surface 4 and above lowermost surface 6. Further, each screening section is preferably disposed inwardly of left end surface 8 and right end surface 10 so that each slot 16 has a closed perimeter.

The width of each of slots 16, when weir A is used in connection with a wash trough, is at least in part based on the effective size of the filter or clarifier layer of a granular media bed. Specifically, the width of the each of the slots 16 of the one or more screening sections 14 is a percentage of effective size of the filter or clarifier layer with the percentage being less than 100%. An optimal percentage is believed to be approximately 75%, which includes 70% to and including 80%.

One example will now be described. In this example, weir A is connected to a wash trough housed in a compartment of a treatment unit above a filter or clarifier bed having a single layer of sand supported by a single layer of support gravel on an underdrain. The effective size of the sand layer is 1.0 mm. Effective size of a layer of granular media as used herein means the size of a screen opening where 90 percent of layer of granular media is retained on the screen and 10 percent passes through the screen. This is a well-known industry definition for effective size.

In this example, where the sand filter or clarifier layer has an effective size(ES) of 1.0 mm, the width of each of the slots 16 of the one or more screening sections 14 is approximately 75% of the effective size of the sand layer, i.e., approximately 0.75 mm. As seen in FIGS. 3, one preferred width of each of the slots 16 of the one or more screening sections 14 is 0.76 mm when the effective size of the sand layer is 1.0 mm.

While FIG. 1 depicts twelve (12) screening sections 14, the number of screening sections can be readily varied as desired.

FIGS. 4 to 6 illustrate two weir plates A with each being connected to a corresponding side wall of a conventional U-shaped wash trough B.

During a washing cycle in which a wash liquid (typically filtered water) is directed upwardly through the sand layer to remove impurities trapped therein during a filtration or clarification cycle, liquid will pass through each of the slots 16 along with fragmented or deteriorated media particles of sand less than 0.76 mm and enter trough B while sand particles larger than 0.76 mm will be prevented from passing through any of the slots 16 of any of the one or more screening sections 14.

In this manner, weir plate A effectively controls the flow of liquid and particles of a size less than the width of the slots 16 into a corresponding trough so that “media fines” are readily removed from the sand layer during a washing cycle while simultaneously retaining in the compartment housing the sand layer the desired size of sand particles, i.e., the non-media fines. Hence, weir A allows for a very effective way to remove “media fines” during a normal washing cycle thereby significantly improving the efficiency of the sand layer during a filtration or clarification cycle.

It is to be noted that during a washing cycle, liquid will also pass over uppermost surface 4 of each of the weir plates A attached to trough B and enter trough B from both sides of trough B.

While FIG. 3 illustrates weir plates A oriented parallel to the direction of gravity, weir plates A can be oriented at an angle to the direction of gravity wherein at least a portion of the weir plate A is not parallel to the direction of gravity. One non-parallel orientation is one in which at least a major portion of the weir plate is angled inwardly so that the weir extends toward a vertical plane passing through a center of a corresponding collection trough, i.e., a lowermost portion of the weir is at a distance from the vertical plane passing through a center of a corresponding collection trough greater than the distance an uppermost portion of the weir is spaced from the same vertical plane. A bottom portion of the weir can have a complimentary shape to that of a corresponding portion of a collection trough to facilitate the connection of the weir to the collection trough.

Another non-parallel orientation is one in which the weir plate is angled outwardly so that at least a major portion of the weir extends away from a vertical plane passing through a center of a corresponding collection trough i.e., a lowermost portion of the weir is at a distance from the vertical plane passing through a center of a corresponding collection trough less than the distance an uppermost portion of the weir is spaced from the same vertical plane. Again, a bottom portion of the weir can have a complimentary shape to that of a corresponding portion of a collection channel to facilitate the connection of the weir to the collection trough.

By orienting the weir in either of the non-parallel positions discussed above, the size of the body of the weir having the one or more screening sections can be increased while still maintaining the uppermost surface of the weir at the same or similar height from the top of the filter/clarifier bed as in the parallel position of the weir. Accordingly, a greater total screening area is created by the larger area of the one or more screening sections oriented in the non-parallel positions.

The non-parallel positioning could be at a 45 degree angle extending either inwardly or outwardly from a vertical plane passing through the junction point of the weir and a corresponding portion of the collection trough.

Trough B, in addition to weir plates A or as a substitute, therefore, can have one of more screening sections formed in one or both of the side walls of trough B where the one or more screenings sections are configured in the same or a similar manner to screening sections 14.

### FIGS. 7 to 13

A preferred form of collection trough and collection trough assembly will now be described in connection with FIGS. 7 to 13.

Referring to FIGS. 7 to 10, a preferred tapered collection trough C will now be described. Tapered trough C preferably includes a planar bottom 20, sidewalls 22 and 24, a first open end 26 and a second open end 28. Side walls 22 and 24 preferably have the same height across the entire length of trough C. In other words, the distance from the upper surface of each of side walls 22 and 24 to a corresponding portion of the bottom 20 is the same or constant across the length of trough C. While bottom 20 of trough C is shown as being planar, bottom 20 could be curved or arcuate as shown in FIGS. 4 and 6.

Trough C can be a shallow wash trough or shallow collection trough having a height that is half (e.g., 12 inches) the height of a conventional wash trough (e.g., 24 inches). This allows the height of the filter bed to be increased by as much as 12 inches and a minimum of 8 inches as explained in U.S. Pat. No. 12,053,722. However, the height of trough C can be readily varied as desired.

As is readily evident from FIGS. 7 to 10, first open end 26 is considerably narrower than second open end 28. For example, the width of second open end 28 can range from two times to five times greater than the width of the first open end 26. As shown in FIG. 8, first open end 26 can have a width of 4 inches and second open end 28 can have a width of 1 foot and 8 inches such that the width of end 28 is five times greater than the width of end 26. The tapered configuration of trough C can result in a considerable material cost savings as well as other advantages discussed below.

As seen in FIG. 8, the tapered configuration of trough C can be achieved by slanting inwardly only side wall 22 from end 28 toward end 26 so that side wall 22 is not perpendicular to the planar end surfaces of bottom 20 adjacent open end 26 and open end 28 while side wall 24 is perpendicular to the planar end surfaces of bottom 20 adjacent open end 26 and open end 28.

However, the taper could be formed by slanting inwardly both side wall 22 and side wall 24.

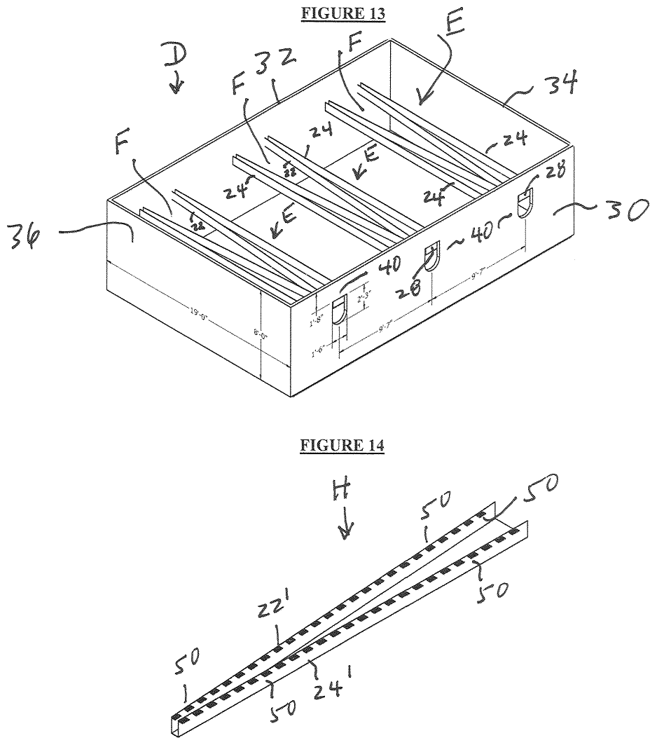

Referring to FIGS. 11 to 13, a preferred wash trough assembly E will now be described. FIG. 13 illustrates a compartment D configured to house a bed of granular media (not shown) above an underdrain (not shown). Compartment D includes four side walls 30, 32, 34 and 36 forming a rectangular shaped compartment of a water or wastewater treatment unit. However, compartment D could be circular or any other desired shape.

Three wash trough assemblies E are shown in compartment D of FIG. 13. Each wash trough assembly E includes at least two tapered wash troughs C. The wider ends (i.e., open ends 28) of each wash trough C of each wash trough assembly E is connected to a corresponding single wash trough opening 40 formed in side wall 30 of compartment D. By this configuration of the three wash trough assemblies E and the three wash trough openings 40, liquid collected during a washing cycle, stage or phase by each of the at least two tapered wash troughs C of a particular wash trough assembly E exit compartment D through the corresponding single wash trough opening 40. An adapter (not shown) of the type disclosed in U.S. Pat. No. 12,053,722 may be used to connect a pair of wash troughs C to a single wash trough opening 40. Where the bottom of each tapered wash trough C is curved as shown in FIGS. 4 and 6, adapter G or adapter I of U.S. Pat. No. 12,053,722 can be used without modification. Where the bottom of each tapered wash trough is planar, a modified form of either adapter G or adapter I of U.S. Pat. No. 12,053,722 in which the recesses and seals of the corresponding adapter are configured to be complimentary to the corresponding open ends 28 of wash trough can be used to connect the ends 28 of a pair of wash troughs C to a single wash trough opening 40.

The slanted side wall 22 of each tapered wash trough C of each wash trough assembly E is oriented to be an inner wall of the wash trough assembly E and non-slanted side wall 24 of each tapered wash trough C of each wash trough assembly E is oriented to be an outer wall of the wash trough assembly E as seen in FIG. 13. Each non-slanted side wall 24 of each tapered wash trough C of each wash trough assembly E are parallel to walls 34 and 36 of compartment D. The above described configuration and orientation of the two tapered wash troughs C of each wash trough assembly E creates an enlarged observation area F adjacent narrower open ends 26 of wash troughs C. The enlarged observation area F allows an individual to readily observe liquid flow during one or more operational stages of the treatment unit including but not limited to a washing cycle, stage or phase.

As seen in FIG. 11 to 13, the distance between two adjacent tapered wash troughs C at open ends 26 is significantly greater than the distance between the two adjacent tapered wash troughs C at open ends 28. In the example depicted in FIG. 11, open ends 26 are spaced a distance of 2 feet and eleven and ⅜ inches from each other and open ends 28 are spaced a distance of 3 and ¼ inches form each other. Open ends 26 of each tapered trough C can be connected to side wall 32 in any suitable manner including but not limited to mounting plates, flanges or brackets.

### FIGS. 14 to 16

Another preferred form of tapered collection trough H will now be described in connection with FIGS. 14 to 16. Tapered collection trough H is similar to tapered collection trough C and, therefore, only the differences will be discussed.

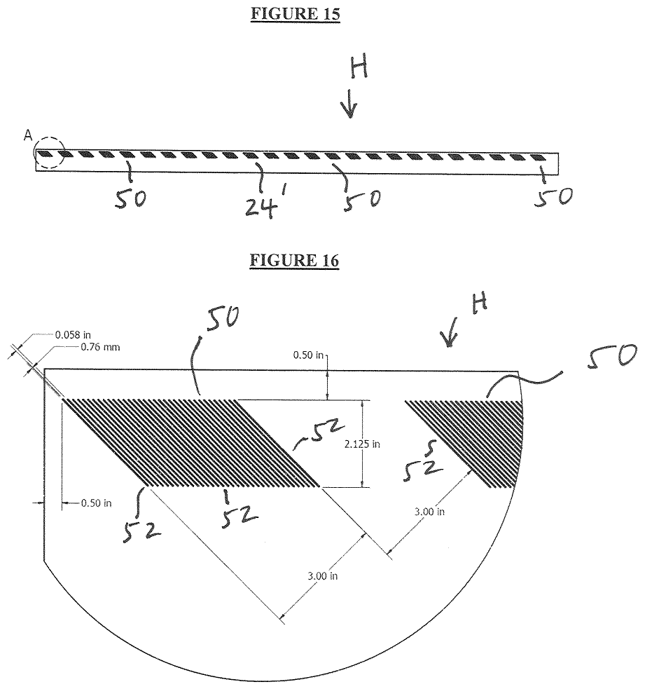

Each of side walls 22′ and 24′ of tapered collection trough H include one or more screening sections schematically shown as the black sections 50 in FIGS. 14 and 15. Each screening section 50 includes a plurality of slanted elongated through slots 52 (shown schematically in black in FIG. 16 where FIG. 16 is an enlargement of circle section “A” of FIG. 15). These through slots 52 (i.e., extending completely through a corresponding side wall) may have a width of 0.76 mm and function in the same manner as slots 16 of screening sections 14. Adjacent slots 52 may be spaced 0.058 inches from each other as shown in FIG. 16. One screening section 50 may be spaced 3 inches from an adjacent screening section as seen in FIG. 16. The height of each screening section 50 may be 2.125 inches and each screening section 50 may be spaced 0.50 inches from the upper surface of a corresponding side wall as shown in FIG. 16. The distance from a first slot 52 and a last slot 52 of a screening section 50 may be 3 inches as shown in FIG. 16. All of the above dimensions may be varied as desired.

### FIGS. 17 to 19

Another preferred form of tapered collection trough J will now be described in connection with FIGS. 17 to 19. Tapered collection trough J is similar to tapered collection trough C and, therefore, only the differences will be discussed.

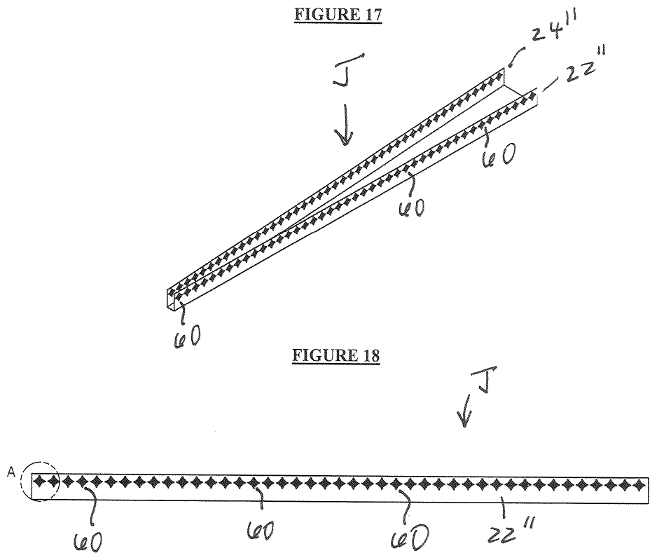

Each of side walls 22″ and 24″ of tapered collection trough J include one or more screening sections schematically shown as the black sections 60 in FIGS. 17 and 18. Each of screening sections 60 have a generally four point star configuration with the upper end, lower end, left end and right end forming the points of the generally four point star configuration.

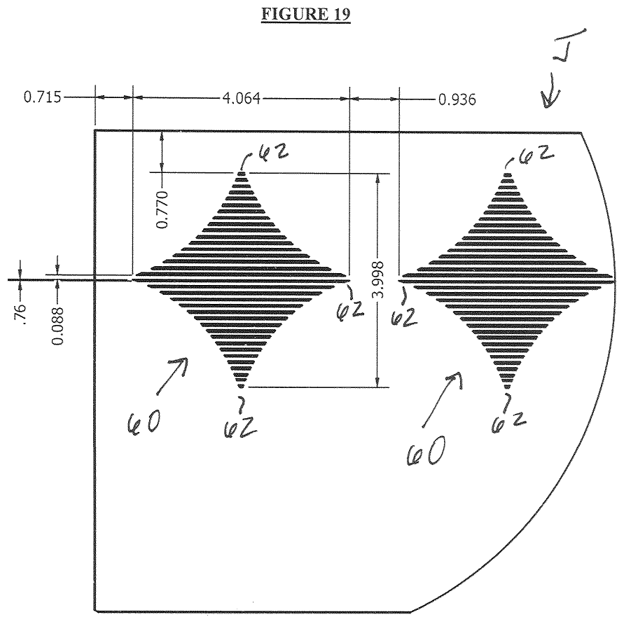

Each screening section 60 includes a plurality of horizontally extending elongated through slots 62 (shown schematically in black in FIG. 19 which is an enlargement of the circle “A” section of FIG. 18). These through slots 62 (which extend completely through a corresponding side wall) may have a width of 0.76 mm and function similar to slots 16 of screening sections 14 as seen in FIG. 19. Each slot 62 may be spaced 0.088 inches from an adjacent slot as shown in FIG. 19. As best seen in FIG. 19, the longest slot of each screening section 60 is the slot or slots positioned at a mid-point of screening section 60 while the shortest slots are positioned at the top and bottom of the screening section 60 as seen in FIG. 19. By varying the length of slots 62 in a screening section 60, it is possible to vary or control the volume of liquid/debris that can flow through each of slots 62 and enter trough J.

One screening section 60 may be spaced 0.936 inches from an adjacent screening section as seen in FIG. 19. The height of each screening section 60 may be 3.998 inches and each screening section 60 may be spaced 0.77 inches from the upper surface of a corresponding side wall as shown in FIG. 19. The width of each screening section 60 may be 4.064 inches as seen in FIG. 19. All of the above dimensions may be varied as desired.

Screening sections 60 can be formed in a weir of the type depicted in FIGS. 1 to 3 in place of or in addition to screening sections 14. Further, screening sections 60 may be used with screening sections 50 in the same side wall of a trough. Any of the troughs described in any of the above embodiments can be formed of any suitable material (e.g., a metal such as stainless steel). Further, the preferred weir can be formed from the same material as a corresponding collection trough or a different material.

While this invention has been described as having preferred designs, it is understood that the preferred designs can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

1. A wash trough assembly for a compartment of a treatment unit housing at least one layer of granular media for removing impurities from water or wastewater passing through the at least one layer of granular media, said wash trough assembly comprising:
(a) at least one wash trough having opposing side walls, a bottom connected to and extending between a lower portion of each of the opposing side walls, a first end and a second end, said first end being configured to be operably associated with a wash trough opening formed in a wall of the compartment of the treatment unit so that a liquid collected by the at least one wash trough exits the compartment of the treatment unit through the wash trough opening;
(b) the wash trough assembly further including at least one of the following:
(i) an adjustable weir connected to one of said opposing side walls of the at least one wash trough, the adjustable weir having at least one screening section including a plurality of slots sized to perform a screening function in which liquid and solid particles having a size less than a predetermined size can pass through anyone of the plurality of slots of the at least one screening section and enter the at least one wash trough through a corresponding slot while solid particles having a size equal to or greater than the predetermined size cannot pass through any of the plurality of slots of the at least one screening section;
(ii) at least one of the opposing side walls of the at least one wash trough having at least one screening section including a plurality of slots sized to perform a screening function in which liquid and solid particles less than a predetermined size can pass through any one of the plurality of slots of the at least one screening section and enter the at least one wash trough through a corresponding slot while solid particles equal to or greater than the predetermined size cannot pass through any of the plurality of slots of the at least one screening section; and,
(iii) the at least one wash trough includes a first wash trough, the opposing side walls of the first wash trough each having a uniform height across a length of at least a major portion of the first wash trough, the bottom of the first wash trough having a varying width over at least a major portion of the first wash trough so that the width of a collection channel formed by the bottom and the opposing side walls varies over at least a major portion of the first wash trough.

2. The wash trough assembly as recited in claim 1, wherein:
(a) at least one of the opposing side walls of the at least one wash trough has at least one screening section including a plurality of slots sized to perform a screening function in which liquid and solid particles less than a predetermined size can pass through any one of the plurality of slots of the at least one screening section and enter the at least one wash trough through a corresponding slot while solid particles equal to or greater than the predetermined size cannot pass through any of the plurality of slots of the at least one screening section.

3. The wash trough assembly as recited in claim 2, wherein:
(a) each of the opposing side walls of the at least one wash trough having a plurality of screening sections, each of the plurality of screenings sections including a plurality of slots sized to perform a screening function in which liquid and solid particles less than a predetermined size can pass through any one of the plurality of slots of the at least one screening section and enter the at least one wash trough through a corresponding slot while solid particles equal to or greater than the predetermined size cannot pass through any of the plurality of slots of the at least one screening section.

4. The wash trough assembly as recited in claim 3, wherein:
(a) each slot of the plurality of slots of each of the plurality of screening sections extends parallel to an adjacent slot and non-parallel to a longitudinal axis of the at least one wash trough.

5. The wash trough assembly as recited in claim 3, wherein:
(a) each slot of the plurality of slots of each of the plurality of screening sections extends parallel to an adjacent slot and parallel to a longitudinal axis of the at least one wash trough with a center slot located in a middle of a corresponding screening section being longer than any other slot of the corresponding screening section, an upper slot and a lower slot of the corresponding screening section are of equal length and are the shortest slots of the corresponding screening section.

6. The wash trough assembly as recited in claim 1, wherein:
(a) the wash trough assembly further includes at least two of the following:
(i) an adjustable weir connected to one of said opposing side walls of the at least one wash trough, the adjustable weir having at least one screening section including a plurality of slots sized to perform a screening function in which liquid and solid particles having a size less than a predetermined size can pass through anyone of the plurality of slots of the at least one screening section and enter the at least one wash trough through a corresponding slot while solid particles having a size equal to or greater than the predetermined size cannot pass through any of the plurality of slots of the at least one screening section;
(ii) at least one of the opposing side walls of the at least one wash trough having at least one screening section including a plurality of slots sized to perform a screening function in which liquid and solid particles less than a predetermined size can pass through any one of the plurality of slots of the at least one screening section and enter the at least one wash trough through a corresponding slot while solid particles equal to or greater than the predetermined size cannot pass through any of the plurality of slots of the at least one screening section; and,
(iii) the at least one wash trough includes a first wash trough, the opposing side walls of the first wash trough each having a uniform height across a length of at least a major portion of the first wash trough, the bottom of the first wash trough having a varying width over at least a major portion of the first wash so that the width of a collection channel formed by the bottom and the opposing side walls varies over at least a major portion of the first wash trough.

7. The wash trough assembly as recited in claim 1, wherein:
(a) the wash trough assembly further includes each of the following:
(i) an adjustable weir connected to one of said opposing side walls of the at least one wash trough, the adjustable weir having at least one screening section including a plurality of slots sized to perform a screening function in which liquid and solid particles having a size less than a predetermined size can pass through anyone of the plurality of slots of the at least one screening section and enter the at least one wash trough through a corresponding slot while solid particles having a size equal to or greater than the predetermined size cannot pass through any of the plurality of slots of the at least one screening section;
(ii) at least one of the opposing side walls of the at least one wash trough having at least one screening section including a plurality of slots sized to perform a screening function in which liquid and solid particles less than a predetermined size can pass through any one of the plurality of slots of the at least one screening section and enter the at least one wash trough through a corresponding slot while solid particles equal to or greater than the predetermined size cannot pass through any of the plurality of slots of the at least one screening section; and,
(iii) the at least one wash trough includes a first wash trough, the opposing side walls of the first wash trough each having a uniform height across a length of at least a major portion of the first wash trough, the bottom of the first wash trough having a varying width over at least a major portion of the first wash so that the width of a collection channel formed by the bottom and the opposing side walls varies over at least a major portion of the first wash trough.

8. An adjustable weir for a collection trough of a treatment unit for treating water or wastewater, said adjustable weir comprising:
(a) a body section extending between a left end, a right end, an upper surface and a lower surface of the adjustable weir, said body section having a plurality of openings configured to receive a fastener to connect the adjustable weir to a side wall of a collection trough, the plurality of openings being sized to allow a position the adjustable weir is connected to the side wall of the collection trough to be varied;
(b) said body section having at least one screening section including a plurality of slots sized to perform a screening function in which liquids and solid particles having a size less than a predetermined size can pass through any of the plurality of slots of the at least one screening section and enter the collection trough through a corresponding slot while solid particles having a size equal to or greater than the predetermined size cannot enter the collection trough through any of the plurality of slots of the at least one screening section.

9. The adjustable weir of claim 8, wherein:
(a) at least one of the slots of the plurality of slots has a length or angle of orientation different from at least one other slot of the plurality of slots.

10. The adjustable weir of claim 8, wherein:
(a) each opening of the plurality of openings having a length greater than a width to permit vertical adjustment of the adjustable weir.

11. The adjustable weir of claim 10, wherein:
(a) the at least one screening section is disposed between said upper surface and the plurality of openings.

12. The adjustable weir of claim 11, wherein:
(a) the at least one screening section includes a plurality of screening sections uniformly spaced along a length of the adjustable weir.

13. The adjustable weir of claim 12, wherein:
(a) each of the plurality of screening sections have an identical configuration.

14. The adjustable weir of claim 8, wherein:
(a) each slot of the plurality of slots of each of the at least one screening section extending parallel to an adjacent slot and parallel to a longitudinal axis of the adjustable weir with a center slot located in a middle of the at least one screening section being longer than any other slot of the at least one screening section and, an uppermost slot and a lowermost slot of the at least one screening section are of equal length and are the shortest slots of the at least one screening section.

15. A wash trough assembly for a compartment of a treatment unit housing at least one layer of granular media for removing impurities from water or wastewater passing through the at least one layer of granular media, said wash trough assembly comprising:
(a) a first wash trough and a second wash trough, said first wash trough and said second wash trough each having an inner wall, an outer wall and a bottom connected to and extending between a lower portion of said inner wall and said outer wall, a first end and a second end;
(b) said first end of each of said first wash trough and said second wash trough being configured to be operably associated with a single wash trough opening formed in a wall of the compartment of the treatment unit so that a liquid collected by each of said first wash trough and said second wash trough exits the compartment of the treatment unit through the single wash trough opening; and,
(c) a width of a collection channel formed by the inner wall, outer wall and bottom of each of said first wash trough and said second wash trough being tapered so that a width of the collection channel at the second end of a corresponding wash trough is less than a width of the collection channel at the first end of the corresponding wash trough creating an enlarged observation area between the first wash trough and the second wash trough adjacent the second end of the first wash trough and the second end of the second wash trough.

16. The wash trough assembly as recited in claim 15, wherein:
(a) the width of the first end of the collection channel of the first wash trough ranges from two times to five times greater than the width of the second end of the collection channel of the first wash trough; and,
(b) the width of the first end of the collection channel of the second wash trough ranges from two times to five times greater than the width of the second end of the collection channel of the second wash trough.

17. The wash trough assembly as recited in claim 15, wherein:
(a) when the first wash trough and second wash trough are connected to the single wash trough opening, the outer wall of the first wash trough extends parallel to the outer wall of the second wash trough.

18. The wash trough assembly as recited in claim 15, wherein:
(a) the outer wall and inner wall of each of said first wash trough and said second wash trough having a plurality of screening sections, each screening section of the plurality of screening sections including a plurality of slots sized to perform a screening function in which liquids and solid particles having a size less than a predetermined size can pass through any of the plurality of slots of any of the plurality of screening sections and enter a corresponding collection channel through a corresponding slot while solid particles having a size equal to or greater than the predetermined size cannot enter the corresponding collection channel through any of the plurality of slots of any of the plurality of screening sections.

19. The wash trough assembly as recited in claim 18, wherein:
(a) the predetermined size is approximately 75% of an effective size of media forming a first filter layer of granular media of the at least one layer of granular media.

20. The wash trough assembly as recited in claim 18, wherein:
(a) each of the plurality of slots of each of the plurality of screening sections has a width of approximately 0.75 mm.
